(19) United States
(12) Patent Application Publication
(10) Pub. No.: US 2025/0315654 A1
(43) Pub. Date: Oct. 9, 2025

(54) METHOD AND APPARATUS FOR INFORMATION PROCESSING

(71) Applicant: Fujitsu Limited, Kawasaki-shi (JP)

(72) Inventor: Yuma ICHIKAWA, Meguro (JP)

(73) Assignee: Fujitsu Limited, Kawasaki-shi (JP)

(21) Appl. No.: 19/074,704

(22) Filed: Mar. 10, 2025

(30) Foreign Application Priority Data
Apr. 3, 2024 (JP) 2024-060119

(51) Int. Cl. G06N 3/0455; G06F 17/18

(52) U.S. Cl. CPC G06N 3/0455; G06F 17/18

(57) ABSTRACT

A computer acquires first sample data included in a data space which conforms to a first probability distribution. The computer selects, by use of a machine learning model that maps the data space and a latent space which conforms to a second probability distribution to each other, a second latent representation in the latent space based on a first latent representation in the latent space. The first latent representation corresponds to the first sample data. The computer outputs, by use of the machine learning model, second sample data corresponding to the second latent representation from among sample data included in the data space.

### CROSS-REFERENCE TO RELATED APPLICATION

This application is based upon and claims the benefit of priority of the prior Japanese Patent Application No. 2024-060119, filed on Apr. 3, 2024, the entire contents of which are incorporated herein by reference.

### FIELD

The embodiments discussed herein relate to a method and apparatus for information processing.

### BACKGROUND

A computer may randomly extract multiple sample data pieces from a data space that conforms to a particular probability distribution. The probability of extracting each sample data piece is preferably consistent with the probability distribution of the data space. For example, in a physical simulation that analyzes the behavior or characteristics of objects, it may be difficult to analytically solve an equation. In that case, a computer may find an approximate solution to the equation by sampling states of the objects. A technique called Monte Carlo is known as one method of extracting sample data pieces from a data space and performing a simulation using the extracted sample data pieces.

When the probability distribution of the data space is complex, it may be difficult to directly extract sample data pieces that conform to the probability distribution using the pure Monte Carlo method. On the other hand, a Markov chain Monte Carlo method (MCMC) continuously extracts sample data pieces so that a set of extracted sample data pieces approximates a particular probability distribution.

A self-learning Monte Carlo (SLMC) method using a variational autoencoder (VAE) has been proposed as one of the techniques related to the Markov chain Monte Carlo method. This related technique randomly selects a feature point according to a normal distribution from an entire latent space indicated by a trained variational autoencoder, and converts the selected feature point into a sample data candidate using a decoder included in the variational autoencoder. The related technique determines whether to adopt the sample data candidate as the next sample data piece based on the relationship between the sample data candidate and a preceding sample data piece extracted before the sample data candidate. See, for example, the following document.

Yuma Ichikawa, Akira Nakagawa, Hiromoto Masayuki and Yuhei Umeda, “Toward Unlimited Self-Learning Monte Carlo with Annealing Process Using VAE's Implicit Isometricity”, arXiv:2211.14024, November 2022

### SUMMARY

According to an aspect, there is provided a non-transitory computer-readable recording medium storing therein a computer program that causes a computer to execute a process including: acquiring first sample data included in a data space which conforms to a first probability distribution; selecting, by use of a machine learning model that maps the data space and a latent space which conforms to a second probability distribution to each other, a second latent representation in the latent space based on a first latent representation in the latent space, the first latent representation corresponding to the first sample data; and outputting, by use of the machine learning model, second sample data corresponding to the second latent representation from among sample data included in the data space.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processor according to a first embodiment;

FIG. 2 illustrates an example of hardware of an information processor according to a second embodiment;

FIG. 3 illustrates an example of a Markov chain Monte Carlo method;

FIG. 4 illustrates an example of a proposal of a next sample by a local transition;

FIG. 5 illustrates an example of sampling from a multimodal distribution;

FIG. 6 illustrates an example of a structure of a variational autoencoder;

FIG. 7 illustrates an example of a proposal of a next sample by a local transition in a latent space;

FIG. 8 illustrates an example of an execution result table;

FIG. 9 illustrates an example of sampling results obtained by independent proposals;

FIG. 10 illustrates an example of sampling results obtained by local transitions;

FIG. 11 is a block diagram illustrating an example of functions of the information processor; and

FIG. 12 is a flowchart illustrating an example of sample generating procedures.

### DESCRIPTION OF EMBODIMENTS

The method of randomly selecting feature points from the entire latent space sometimes generates many sample data candidates with low probability of being adopted due to the relationship with their preceding sample data pieces. As a result, the number of sample data candidates to be rejected may increase, which may result in extending the time for extracting a sufficient number of sample data pieces.

Several embodiments will be described below with reference to the accompanying drawings. Note that multiple embodiments may be combined for implementation. Note that in the following embodiments, the term “sampling” may be used to refer to the process of generating multiple sample data pieces (random numbers) that conform to a particular probability distribution in a data space.

### (a) First Embodiment

An information processor 10 of a first embodiment extracts a set of sample data pieces that conforms to a particular probability distribution using the Markov chain Monte Carlo method. The extracted set of sample data pieces may be used for various numerical calculations, such as physical simulations that calculate approximate solutions to equations that are difficult to solve analytically. Such numerical calculations may be performed by the information processor 10 or by different information processors. The information processor 10 may be a client device or a server device. The information processor 10 may be called a computer, a sampling apparatus, a machine learning apparatus, or a simulation apparatus.

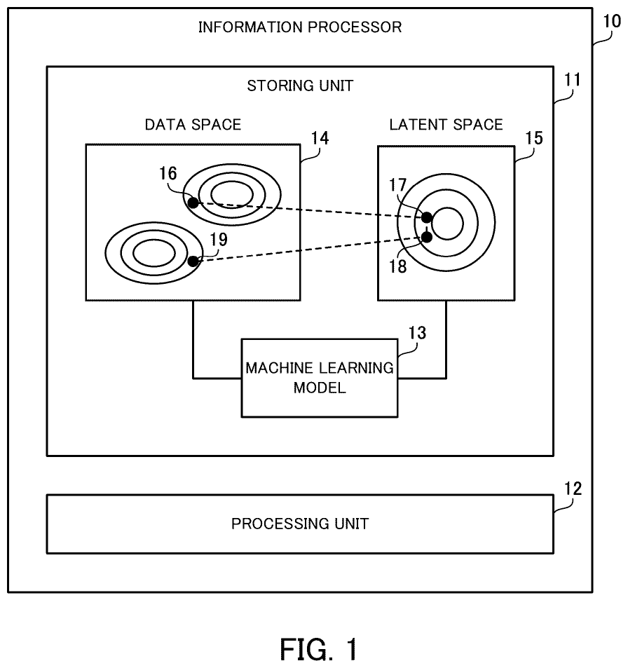

FIG. 1 illustrates an information processor according to a first embodiment. The information processor 10 includes a storing unit 11 and a processing unit 12. The storing unit 11 may be volatile semiconductor memory, such as random access memory (RAM), or a non-volatile storage device, such as a hard disk drive (HDD) or flash memory.

The processing unit 12 is, for example, a processor, such as a central processing unit (CPU), graphics processing unit (GPU), or digital signal processor (DSP). Note however that the processing unit 12 may include an electronic circuit, such as an application specific integrated circuit (ASIC) or field programmable gate array (FPGA). The processor executes programs stored in memory, such as RAM, (or stored in the storing unit 11). The processor may be referred to as a processor circuitry. The term “multiprocessor”, or simply “processor”, may be used to refer to a set of multiple processors. Different processes among multiple processes described below may be executed by different processors.

The storing unit 11 stores therein a trained machine learning model 13. The machine learning model 13 maps a data space 14 and a latent space 15 to each other. The data space 14 is a space to which sample data pieces belong, and conforms to a first probability distribution. The data space 14 is defined according to a sampling target, such as a state of a simulation object. The probability distribution of the data space 14 is mathematically given based on prior knowledge of the sampling target, such as a physical law. The latent space 15 is a space to which latent representations (feature points) corresponding to sample data pieces belong, and conforms to a second probability distribution. The latent representations may be called latent variables or feature vectors.

Examples of the machine learning model 13 include a variational autoencoder, a flow-based model, a restricted Boltzmann machine (RBM), and the like. The variational autoencoder includes an encoder and a decoder. The encoder converts a sample data piece included in the data space 14 into a latent representation in the latent space 15. The decoder converts a latent representation in the latent space 15 into a sample data piece included in the data space 14.

Each sample data piece may be vector data including components of multiple dimensions. Each latent representation may be vector data including components of multiple dimensions. The vector data may be continuous data in which the individual components are continuous values, or may be discrete data in which the individual components are discrete values. The discrete data may be binary data in which each component is 0 or 1.

Typically, the probability distribution of the latent space 15 is less complex than the probability distribution of the data space 14. For example, the number of dimensions of the latent space 15 is smaller than the number of dimensions of the data space 14. In addition, for example, the probability distribution of the data space 14 is a multimodal distribution having multiple probability peaks (maximum values) while the probability distribution of the latent space 15 is a unimodal distribution having only one probability peak. The probability distribution of the data space 14 may be a Gaussian mixture model (GMM) represented by a weighted sum of multiple normal distributions (multiple Gaussian distributions).

The machine learning model 13 may be trained so that the distribution of latent representations in the latent space 15 forms a desired probability distribution. The probability distribution of the latent space 15 is preferably a probability distribution that is easier to sample compared to the data space 14. Examples of the probability distribution of the latent space 15 include a multivariate standard normal distribution, a Gaussian mixture model, a Bernoulli distribution, and a beta distribution. The latent space 15 may have isometricity. Isometricity is a distribution characteristic in which the distance between two latent representations in the latent space 15 is proportional to the distance, in the data space 14, between two sample data pieces corresponding to the two latent representations.

The machine learning model 13 is trained using training data. The machine learning model 13 may be trained by the information processor 10 or a different information processor. The training data includes sample data pieces belonging to the data space 14. The training of the machine learning model 13 may be unsupervised learning, and there may be no latent representations belonging to the latent space 15 in the training data. For example, the machine learning inputs a sample data piece to the encoder, adds a random number to the output of the encoder to select a latent representation, and inputs the selected latent representation to the decoder. The machine learning optimizes parameter values of the encoder and the decoder by error backpropagation in such a manner as to reduce the error between the output of the decoder and the original sample data piece.

The training data may be provided by a user. The training data may be generated by the information processor 10 or a different information processor. In that case, sample data pieces included in the training data may be extracted from the data space 14 by a sampling method different from the first embodiment. The different sampling method may be less accurate than the first embodiment, and may be a different Markov chain Monte Carlo method. While performing the sampling described below, the information processor 10 may add the extracted sample data pieces to the training data and then retrain the machine learning model 13.

The processing unit 12 continuously extracts a sample data piece from the data space 14 using the machine learning model 13 stored in the storing unit 11. First, the processing unit 12 acquires a sample data piece 16 included in the data space 14. The sample data piece 16 is an initial value of the sample data pieces or an immediately preceding sample data piece extracted before the current one. The initial value may be provided by the user, or may be a value selected based on the probability distribution of the data space 14, such as the median of the probability distribution of the data space 14.

Next, the processing unit 12 uses the machine learning model 13 to select a latent representation 18 in the latent space 15 based on a latent representation 17 in the latent space 15, which corresponds to the sample data piece 16. The selection of the latent representation 18 based on the latent representation 17 may be referred to as a local transition from the latent representation 17 to the latent representation 18.

At this time, the processing unit 12 may convert the sample data piece 16 into the latent representation 17 using the machine learning model 13. For example, the processing unit 12 uses the encoder included in the variational autoencoder to convert the sample data piece 16 into the latent representation 17. Note however that, if the sample data piece 16 is a previously extracted one, the latent representation previously selected as a transition destination may already be known. In that case, the processing unit 12 may identify the known latent representation corresponding to the sample data piece 16 as the latent representation 17.

The processing unit 12 may randomly select the latent representation 18 from a region in the latent space 15, which is within a certain range of the latent representation 17. For example, the processing unit 12 selects the latent representation 18 from the periphery of the latent representation 17 according to a uniform distribution or normal distribution of a certain width centered on the latent representation 17. Alternatively, the processing unit 12 may select the latent representation 18 based on the probability distribution of the latent space 15, or may select the latent representation 18 using the gradient of the probability distribution at the latent representation 17.

For example, the processing unit 12 employs a gradient-based local transition algorithm, such as a Hamiltonian Monte Carlo method or Langevin Monte Carlo method. With the gradient-based local transition algorithm, a transition probability according to a gradient is given to each direction from the latent representation 17 in the latent space 15, and a transition destination is selected randomly according to the transition probabilities. Typically, a transition is likely to be made in a direction coming closer to the peak of the probability distribution, and is unlikely to be made in a direction away from the peak.

Next, using the machine learning model 13, the processing unit 12 outputs a sample data piece 19 corresponding to the latent representation 18 amongst sample data pieces included in the data space 14. At this time, the processing unit 12 may convert the latent representation 18 into the sample data piece 19 using the machine learning model 13. For example, the processing unit 12 uses the decoder included in the variational autoencoder to convert the latent representation 18 into the sample data piece 19.

The processing unit 12 may calculate an adoption probability of the sample data piece 19 from the relationship between the sample data piece 16 and the sample data piece 19. In this case, the processing unit 12 stochastically determines whether to adopt the sample data piece 19 as the next sample data piece after the sample data piece 16 according to the adoption probability. Typically, the larger the adoption probability, the more likely the sample data piece 19 is to be adopted, and the smaller the adoption probability, the less likely the sample data piece 19 is to be adopted. For example, the processing unit 12 selects a random number from a uniform distribution in the range of 0 to 1, inclusive, and adopts the sample data piece 19 as the next sample data piece after the sample data piece 16 if the random number is less than the adoption probability.

The processing unit 12 may calculate the adoption probability using the transition probability of transitioning from the latent representation 17 to the latent representation 18, the occurrence probability of the sample data piece 16 indicated by the probability distribution of the data space 14, and the occurrence probability of the sample data piece 19 indicated by the probability distribution of the data space 14. The transition probability is determined by a method used for the local transition in the latent space 15 and the selected latent representation 18. The occurrence probabilities of the sample data pieces 16 and 19 are determined by the known probability distribution of the sampling target.

When the sample data piece 19 is rejected, the processing unit 12 may again extract the next sample data candidate following the sample data piece 16 in the same manner as described above. Alternatively, the processing unit 12 may again designate the sample data piece 16 as the next one by interpreting that the sequence of sample data pieces remains at the same point in the data space 14. When the next sample data piece is determined, the processing unit 12 may use the determined sample data piece as the sample data piece 16 to further extract a new sample data piece in the same manner as described above. The processing unit 12 may repeat the above method until a certain number of sample data pieces are extracted.

As has been described above, the information processor 10 of the first embodiment acquires the sample data piece 16 included in the data space 14 which conforms to the first probability distribution. By use of the machine learning model 13 that maps the data space 14 and the latent space 15 which conforms to a second probability distribution to each other, the information processor 10 selects the latent representation 18 in the latent space 15 based on the latent representation 17 in the latent space 15, which corresponds to the sample data piece 16. By use of the machine learning model 13, the information processor 10 outputs the sample data piece 19 corresponding to the latent representation 18 from among sample data pieces included in the data space 14.

Herewith, even if the data space 14 is high-dimensional, the information processor 10 is able to extract sample data pieces to conform to the probability distribution of the data space 14. In addition, because of using the machine learning model 13 to propose the next sample data piece, the information processor 10 is able to adjust the proposal method according to the sampling target and therefore extract high-quality sample data pieces.

Furthermore, because of performing state transitions in the latent space 15 converted from the data space 14, the information processor 10 is able to reduce the risk of biased sampling that deviates from the probability distribution of the data space 14 even if the probability distribution is a multimodal distribution. In addition, because of performing local transitions in the latent space 15, the information processor 10 is able to increase the adoption probabilities of proposed sample data pieces compared to the case where the next latent representation is selected independently of the preceding latent representation. Thus, the information processor 10 is able to improve sampling efficiency.

Note that the machine learning model 13 may be a variational autoencoder. The information processor 10 may convert the sample data piece 16 into the latent representation 17 using an encoder included in the variational autoencoder, and may convert the latent representation 18 into the sample data piece 19 using a decoder included in the variational autoencoder. This allows the information processor 10 to map the data space 14 and the latent space 15 to each other with high accuracy, and improve the sampling accuracy in the data space 14 through adjustment of local transitions in the latent space 15.

Furthermore, the information processor 10 may select the latent representation 18 by stochastically transitioning the latent representation 17 using the gradient of the probability distribution of the latent space 15 at the latent representation 17. This improves the adoption probability of a proposed sample data piece. In addition, the information processor 10 may calculate the adoption probability indicating whether to adopt the sample data piece 19 based on the transition probability of transitioning from the latent representation 17 to the latent representation 18, the occurrence probability of the sample data piece 16, and the occurrence probability of the sample data piece 19. This allows the information processor 10 to calculate an appropriate adoption probability in such a manner that the sequence of adopted sample data pieces is consistent with the probability distribution of the data space 14.

### (b) Second Embodiment

An information processor 100 of a second embodiment extracts a sequence of sample data pieces from a data space by a self-learning Monte Carlo method using a variational autoencoder. In the second embodiment, sample data pieces may be simply called samples. The information processor 100 may be a client device or a server device. The information processor 100 corresponds to the information processor 10 of the first embodiment. Note that, in the following, the information processor 100 performs both training and utilization of the variational autoencoder; however, these operations may be performed by different information processors.

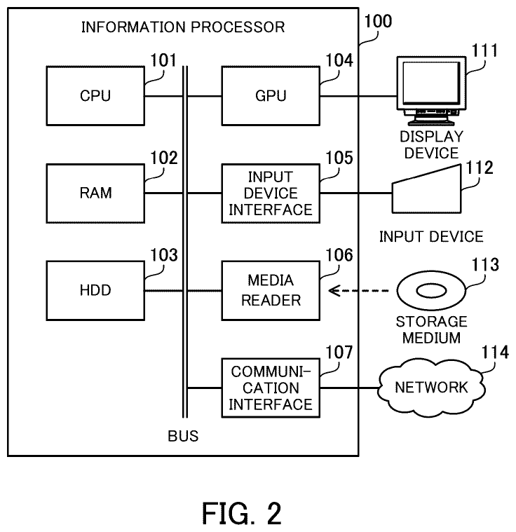

FIG. 2 illustrates a hardware example of the information processor of the second embodiment. The information processor 100 includes a CPU 101, a RAM 102, an HDD 103, a GPU 104, an input device interface 105, a media reader 106, and a communication interface 107, which are all connected to a bus. The CPU 101 corresponds to the processing unit 12 of the first embodiment. The RAM 102 or the HDD 103 corresponds to the storing unit 11 of the first embodiment.

The CPU 101 is a processor configured to execute program instructions. The CPU 101 reads out programs and data stored in the HDD 103, loads them into the RAM 102, and executes the loaded programs. Note that the information processor 100 may include two or more processors.

The RAM 102 is volatile semiconductor memory for temporarily storing therein programs to be executed by the CPU 101 and data to be used by the CPU 101 for its computation. The information processor 100 may be provided with a different type of volatile memory other than RAM.

The HDD 103 is a non-volatile storage device to store therein data and software programs, such as an operating system (OS), middleware, and application software. The information processor 100 may be provided with a different type of non-volatile storage device, such as flash memory or a solid state drive (SSD).

The GPU 104 performs image processing in cooperation with the CPU 101, and displays video images on a screen of a display device 111 coupled to the information processor 100. The display device 111 may be a cathode ray tube (CRT) display, a liquid crystal display (LCD), an organic electro-luminescence (OEL) display, or a projector. An output device, such as a printer, other than the display device 111 may be connected to the information processor 100.

In addition, the GPU 104 may be used as a general-purpose computing on graphics processing unit (GPGPU). The GPU 104 may execute a program according to an instruction from the CPU 101. The information processor 100 may have volatile semiconductor memory other than the RAM 102 as GPU memory.

The input device interface 105 receives an input signal from an input device 112 connected to the information processor 100. Various types of input devices may be used as the input device 112, for example, a mouse, a touch panel, or a keyboard. Multiple types of input devices may be connected to the information processor 100.

The media reader 106 is a device for reading programs and data recorded on a storage medium 113. The storage medium 113 may be, for example, a magnetic disk, an optical disk, or semiconductor memory. Examples of the magnetic disk include a flexible disk (FD) and HDD. Examples of the optical disk include a compact disc (CD) and digital versatile disc (DVD). The media reader 106 copies the programs and data read out from the storage medium 113 to a different storage medium, for example, the RAM 102 or the HDD 103. The read programs may be executed by the CPU 101.

The storage medium 113 may be a portable storage medium and used to distribute the programs and data. In addition, the storage medium 113 and the HDD 103 may be referred to as computer-readable storage media.

The communication interface 107 communicates with different information processors via a network 114. The communication interface 107 may be a wired communication interface connected to a wired communication device, such as a switch or router, or may be a wireless communication interface connected to a wireless communication device, such as a base station or access point.

Next described is the Monte Carlo method. The Monte Carlo method extracts a large number of samples from a data space to which a sampling target belongs in such a manner as to conform to a specified probability distribution. Typically, the data space is a high dimensional space, and the samples are high-dimensional numerical vectors. The extracted samples may be used for various numerical calculations.

For example, physical simulations may solve multi-body problems that analyze the behavior and physical properties of three or more interacting objects. Equations defined in such multi-body problems are often difficult to solve analytically. In view of this, physical simulations may sample the states of the objects and combine computational results for each sample to obtain an approximate solution to a multi-body problem.

Examples of such physical simulations include quantum chemical simulations and quantum computing simulations. Quantum chemical simulations may calculate the ground state energy of a molecule with multiple electrons. In this case, the quantum chemical simulations may extract samples of the electronic state of the molecule from a probability distribution defined by a wave function. Quantum computing simulations may simulate the behavior of a quantum computer. In this case, the quantum computing simulations may stochastically extract measurements from a quantum state defined by multiple qubits.

The Monte Carlo method may also be used in statistical processing such as Bayesian inference. In Bayesian inference, experimentally obtained observation data is fitted to a model to estimate unknown parameter values of the model. In this case, when it is difficult to analytically obtain the posterior distribution of the parameter values, Bayesian inference may extract samples from the posterior distribution.

However, when the probability distribution of a sampling target is high dimensional, it is difficult to directly extract individual samples from such a probability distribution. In this case, the Markov chain Monte Carlo method may be employed. A Markov chain is a stochastic process in which the current state depends only on a state attained immediately before the current state. The Markov chain Monte Carlo method extracts the next sample depending on an immediately preceding sample. The Markov chain Monte Carlo method continuously extracts samples according to a certain algorithm to thereby make a sample sequence approximate a given probability distribution.

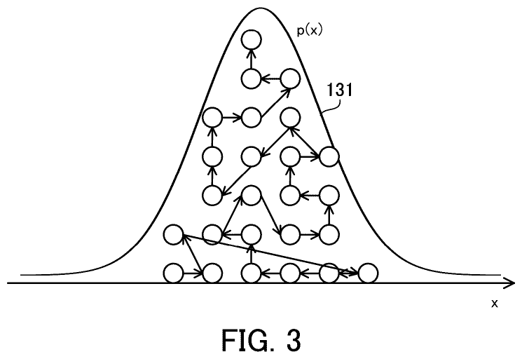

FIG. 3 illustrates an example of the Markov chain Monte Carlo method. In the example of FIG. 3, multiple samples are extracted from a probability distribution 131 defined by p(x). State x is a random variable indicating points in a data space to which the samples belong. An instance in the data space extracted by selecting a state once corresponds to a sample. Note however that, for the sake of explanation, no clear distinction may be made between a state and a sample in the second embodiment.

Each sample other than the initial value of the samples depends only on its immediately preceding sample. Therefore, multiple extracted samples are represented by a single trajectory with no branching. By increasing the number of samples, the distribution of the samples approximates the probability distribution 131. In a sufficiently good sample sequence, state x with a larger probability p(x) occurs more frequently, and state x with a smaller probability p(x) occurs less frequently.

A specific algorithm of the Markov chain Monte Carlo method is defined in such a manner that the transition probability of transitioning from state x to state x′ satisfies the balance condition and the ergodic condition. The balance condition indicates that the input and output of state x′ are stochastically balanced in relation to all other states, and is defined as Equation (1). K(x′|x) represents the transition probability of transitioning from state x to state x′; p(x) represents the probability of state x; and p(x′) represents the probability of state x′. The ergodic condition indicates that, for any two states, the transition probability between them is not 0, and it is possible to transition from one state to the other in a finite time (finite sampling number of times).

$$\int p ( x ) ( {x}^{′} \vert x ) dx = p ( {x}^{′} ) \qquad ( 1 )$$

Note however that, when trying to directly design an algorithm that guarantees the balance condition, the algorithm may become complicated. For this reason, an algorithm may be designed to satisfy the detailed balance condition in place of the balance condition. The detailed balance condition is more restrictive than the balance condition, and is a sufficient condition for the balance condition. The detailed balance condition indicates that the mutual input and output between any two states are stochastically balanced, and is defined as Equation (2). K(x|x′) represents the transition probability of transitioning from state x′ to state x.

$$p ( x ) ( {x}^{′} \vert x ) = p ( {x}^{′} ) ( x \vert {x}^{′} ) \qquad ( 2 )$$

Next described is a Metropolis method, which is one implementation of the Markov chain Monte Carlo method. The Metropolis method is designed to satisfy the detailed balance condition. The Metropolis method assumes a certain proposal distribution q(x′|x). The proposal distribution q(x′|x) is a function that stochastically proposes state x′ of a transition destination from the current state x. The proposal distribution q(x′|x) may be given by a user, and is preferably a function that is easy to directly sample. In theory, the proposal distribution q(x′|x) may be any function. Typically, the proposal distribution q(x′|x) is a local proposal distribution that utilizes a local transition from state x.

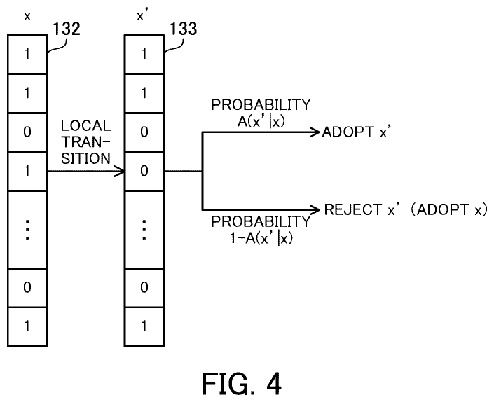

FIG. 4 illustrates an example of a proposal of the next sample by a local transition. A local proposal distribution calculates, based on the current state x, the transition probabilities of the surrounding states, and randomly proposes the next state x′ according to the transition probabilities. For example, the local proposal distribution randomly selects state x′ from a uniform distribution or normal distribution with a certain width centered on the current state x.

As an example, a sample 132 is a binary vector in which each component of multiple dimensions is 0 or 1, and represents state x. The local proposal distribution proposes a sample 133 from the sample 132. The sample 133 is a binary vector with the same number of dimensions as the sample 132, and represents state x′. The local proposal distribution randomly selects one dimension from the multiple dimensions included in the sample 132, and inverts the component of the selected dimension. If the component of the selected dimension is 0, it is changed to 1, and if the component of the selected dimension is 1, it is changed to 0. In the example of FIG. 4, the component of the fourth dimension is changed. In this manner, state x′ is proposed from state x.

When the Metropolis method selects state x′ as a candidate for the next state of state x, it calculates an adoption probability A(x′|x) defined by Equation (3). The adoption probability A(x′|x) is a real number between 0 and 1, inclusive. The adoption probability A(x′|x) is calculated using the probability p(x) of state x, the probability p(x′) of state x′, the transition probability q(x′|x) of transitioning from state x to state x′, and a transition probability q(x|x′) of transitioning from state x′ to state x. The transition probabilities q(x′|x) and q(x|x′) are determined by the local proposal distribution to be used. In the example of FIG. 4, the transition probabilities q(x′|x) and q(x|x′) are each obtained by dividing 1 by the number of dimensions.

$$A ( {x}^{′} \vert x ) = min ( 1 , \frac{p ( {x}^{′} ) q ( x \vert {x}^{′} )}{p ( x ) q ( {x}^{′} \vert x )} ) \qquad ( 3 )$$

The Metropolis method adopts state x′ with the probability A(x′|x) and extracts a sample representing state x′. For example, the Metropolis method generates a random number r from a uniform distribution in the range of 0 to 1, inclusive, and adopts state x′ if the random number r is less than the adoption probability A(x′|x). On the other hand, the Metropolis method rejects state x′ with a probability of 1−A(x′|x) and does not extract the sample representing state x′. This means that the current state remains as state x. For example, the Metropolis method extracts again the sample representing state x.

When the transition probability q(x′|x) and the transition probability q(x|x′) are symmetric, the adoption probability A(x′|x) is determined according to the magnitude relationship between the probability p(x) of state x and the probability p(x′) of state x′. When the probability p(x′) is equal to or greater than the probability p(x), the current state transitions to state x′. When the probability p(x′) is less than the probability p(x), the current state transitions to state x′ with the probability A(x′|x) and remains as state x with the probability 1−A(x′|x). Therefore, the current state is likely to transition toward the peak of the probability distribution p(x) and to remain near the peak.

Note however that the probability distribution of a sampling target may be a multimodal distribution having multiple peaks. A multimodal distribution may be expressed, for example, by a Gaussian mixture distribution, which is a weighted sum of multiple normal distributions. In that case, a proposal distribution that performs simple local transitions in a data space may fail to allow the current state to escape from a subregion, and thus a sample sequence may fail to approximate the probability distribution p(x).

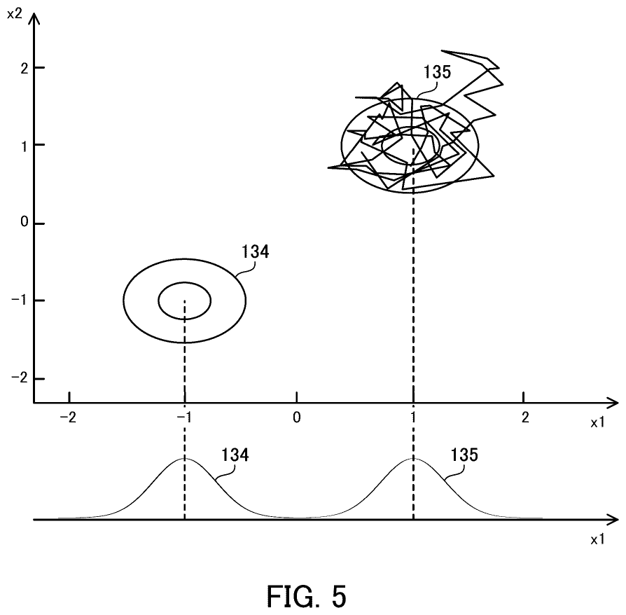

FIG. 5 illustrates an example of sampling from a multimodal distribution. For ease of explanation, in FIG. 5, the data space is expressed in two dimensions including an x1 axis and an x2 axis. The probability distribution p(x) of a sampling target is a multimodal distribution expressed as a weighted sum of probability distributions 134 and 135. FIG. 5 depicts a trajectory indicating the extraction order of multiple samples. In the example of FIG. 5, a sample far from the peak of the probability distribution 134 is used as an initial value, and a sequence of samples is extracted by simple local transitions. While samples are extracted from around the peak of the probability distribution 135, no samples are extracted from around the peak of the probability distribution 134. As a result, the extracted sample sequence fails to approximate the entire probability distribution p(x).

On the other hand, the Metropolis method may use a proposal distribution q(x′) in which the proposal probability of state x′ does not depend on the current state x, in place of the proposal distribution q(x′|x) in which the proposal probability of state x′ depends on the current state x. The proposal distribution q(x′) is an independent proposal distribution using an independent sampler. In the example of FIG. 4, for example, the independent proposal distribution randomly determines the component (0 or 1) of each dimension regardless of the sample 132 to generate a new sample. The independent proposal distribution globally selects the next state x′, thereby reducing the risk that the transition destination will be confined to a partial region.

The Metropolis method using the independent proposal distribution calculates the adoption probability A(x′|x) defined by Equation (4) and determines whether to adopt or reject state x′ according to the adoption probability A(x′|x). If the independent proposal distribution more closely approximates the original probability distribution of a sampling target, the adoption probability A(x′|x) will be closer to 1. On the other hand, when the independent proposal distribution deviates more from the original probability distribution, the adoption probability A(x′|x) becomes lower. As a result, state changes are less likely to occur, and it may take a long time to obtain a sample sequence consistent with the probability distribution p(x).

$$A ( {x}^{′} \vert x ) = min ( 1 , \frac{p ( {x}^{′} ) q ( x )}{p ( x ) q ( {x}^{′} )} ) \qquad ( 4 )$$

In this regard, a self-learning Monte Carlo method uses machine learning technology to prepare an appropriate proposal distribution according to a sampling target. Machine learning models may be able to implement a proposal distribution that approximates the original probability distribution p(x) of a sampling target and allows the next state to be easily selected. In view of this, the information processor 100 of the second embodiment employs a self-learning Monte Carlo method that uses a variational autoencoder as a machine learning model. As described below, the information processor 100 implements the self-learning Monte Carlo method so as to be applied to a multimodal distribution and increase the adoption probability A(x′|x).

A variational autoencoder is described in the following literature, for example: Diederik P. Kingma and Max Welling, “Auto-Encoding Variational Bayes”, Proc. of the 2nd International Conference on Learning Representations (ICLR 2014), April 2014.

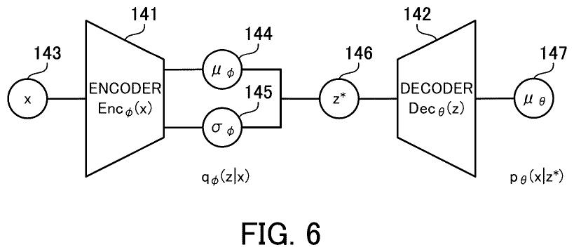

FIG. 6 illustrates an example of the structure of a variational autoencoder. The variational autoencoder includes an encoder 141 and a decoder 142. The encoder 141 is a neural network with parameters φ trained by machine learning. The decoder 142 is a neural network with parameters θ trained by machine learning.

The encoder 141 receives a sample 143 in a data space. The sample 143 is, for example, a high-dimensional numerical vector with about tens to thousands of dimensions. Each dimensional component of the sample 143 may be a discrete value or a continuous value. The encoder 141 calculates a mean 144 and a standard deviation 145 from the sample 143.

The variational autoencoder stochastically selects a feature point 146 in a latent space according to a probability distribution defined by the mean 144 and the standard deviation 145. The feature point 146 may be called a latent variable, a latent state, a latent representation, or a feature vector. The number of dimensions of the feature point 146 is smaller than that of the sample 143. The feature point 146 is a low-dimensional numerical vector, for example, having about several to several tens of dimensions. For example, the variational autoencoder extracts a random number from a multivariate standard normal distribution and multiplying the standard deviation 145 by the random number and adds the results to the mean 144 to thereby obtain the feature point 146.

The decoder 142 receives the feature point 146 and generates a sample 147 from the feature point 146. When the feature point 146 is generated from the sample 143, then the sample 147 is preferably similar to the sample 143.

In machine learning, the information processor 100 prepares training data including multiple samples. The information processor 100 may receive the training data from a user. Alternatively, the information processor 100 may generate the training data by extracting multiple samples from a specified probability distribution. Examples of a sampling method for generating the training data include the method described in the aforementioned literature “Toward Unlimited Self-Learning Monte Carlo with Annealing Process Using VAE's Implicit Isometricity”, a replica exchange Monte Carlo method, and a molecular dynamics-based method. In the replica exchange Monte Carlo method, the Markov chain Monte Carlo method is carried out independently for each of multiple probability distributions, and samples are exchanged between different probability distributions on a regular basis.

The information processor 100 inputs each sample included in the training data to the encoder 141, and trains the parameters φ and θ by error backpropagation in such a manner as to reduce the error between an input of the encoder 141 and an output of the decoder 142. At this time, the information processor 100 trains the parameters φ and θ so that multiple feature points corresponding to multiple samples included in the training data conform to a probability distribution that is easy to sample, such as a multivariate standard normal distribution. Since the feature points input to the decoder 142 fluctuate due to the influence of random numbers, the variational autoencoder is trained so that the distribution of the feature points in the latent space forms a certain probability distribution.

Herewith, the variational autoencoder learns the distribution of the samples included in the training data and maps the probability distribution in the data space to a certain probability distribution in the latent space. In a well-trained variational autoencoder, the latent space may have isometricity. In this case, the data space and the latent space are mapped to each other so that the distance between two samples in the data space is proportional to the distance between the corresponding two feature points in the latent space. If the probability distribution in the data space is multimodal, a well-trained variational autoencoder may convert a local transition in the latent space into a meaningful global transition in the data space. Such meaningful global transitions include transitions from state x belonging to one local peak to state x′ belonging to another local peak.

The information processor 100 selects a candidate for the next sample using the trained variational autoencoder as a proposal distribution. At this time, the information processor 100 uses the variational autoencoder as a local proposal distribution by performing a local transition of a feature point in the latent space.

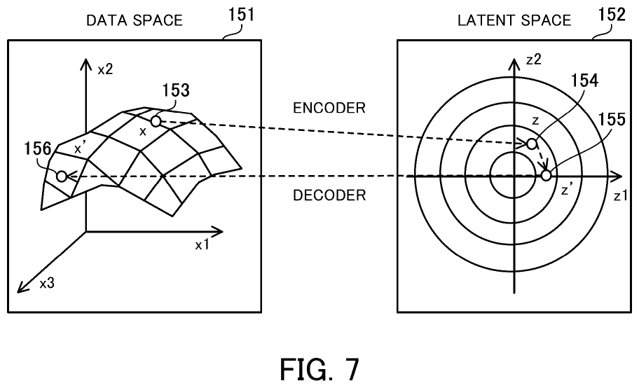

FIG. 7 illustrates an example of a proposal of the next sample by a local transition in a latent space. The information processor 100 identifies a sample 153 included in a data space 151. The sample 153 is an initial value or an immediately preceding sample. The information processor 100 inputs the sample 153 to the encoder 141, thereby converting the sample 153 into a feature point 154 included in a latent space 152. The feature point 154 may be a mean value output by the encoder 141, or may be a feature point extracted from the periphery of the mean value using a random number.

The information processor 100 stochastically selects a feature point 155 from the feature point 154 according to a certain local transition algorithm. The information processor 100 of the second embodiment employs an algorithm that uses the gradient of a probability distribution (e.g., a multivariate standard normal distribution) in the latent space 152 as the local transition algorithm. Usually, the transition probability in the direction toward the peak of the probability distribution is large, and the transition probability in the direction away from the peak is small. Examples of such a local transition algorithm include the Hamiltonian Monte Carlo method and the Langevin Monte Carlo method.

The Hamiltonian Monte Carlo method regards a feature point in the latent space 152 as a position and a random number as a momentum, and defines transition probabilities for the peripheries of the feature point 154 by a leapfrog method or the like according to the equations of motion. According to the defined transition probabilities, the Hamiltonian Monte Carlo method randomly selects the feature point 155 of the transition destination.

On the other hand, the Langevin Monte Carlo method obtains a logarithmic gradient of the probability of the feature point 154 from the probability distribution of the latent space 152 defined by a variational autoencoder. The Langevin Monte Carlo method multiplies the gradient by a constant α and then adds the results to the feature point 154 to calculate a reference point that is shifted from the feature point 154 by the amount according to the gradient. Then, the Langevin Monte Carlo method uses a normal distribution centered on the reference point to specify transition probabilities for the peripheries of the feature point 154, and randomly selects the feature point 155 of the transition destination according to the transition probabilities.

The information processor 100 converts the feature point 155 into a sample 156 included in the data space 151 by inputting the feature point 155 to the decoder 142. The information processor 100 selects the sample 156 as a candidate for the next sample following the sample 153. Note that the samples 153 and 156 correspond to the sample data pieces 16 and 19 of the first embodiment. The feature points 154 and 155 correspond to the latent representations 17 and 18 of the first embodiment. The information processor 100 calculates the adoption probability of selecting the sample 156 after the sample 153 according to Equation (3), and determines whether to adopt or reject the sample 156 according to the adoption probability.

Here, the information processor 100 uses a transition probability q_{θ,φ}(x′|x) of Equation (5) as the transition probability q(x′|x) in Equation (3). q_{φ}(z|x) indicates the probability that the encoder 141 converts the sample 153 into the feature point 154. K_{z}(z′|z) indicates the transition probability of transitioning from the feature point 154 to the feature point 155. p_{θ}(x′|z′) indicates the probability that the decoder 142 converts the feature point 155 into the sample 156.

$${q}_{θ , ϕ} ( {x}^{′} \vert x ) = {q}_{ϕ} ( z \vert x ) {z}_{} ( {z}^{′} \vert z ) {p}_{θ} ( {x}^{′} \vert {z}^{′} ) \qquad ( 5 )$$

K_{z}(z′|z) is calculated according to the local transition algorithm used in the latent space 152. q_{φ}(z|x) and p_{θ}(x′|z′) are defined by the correspondence between the data space 151 and the latent space 152, which the variational autoencoder learns, and are calculated from the inputs and outputs of the encoder 141 and the decoder 142. The local transition algorithm is implemented so that the transition probability K_{z}(z′|z) satisfies the balance condition of Equation (6). p(z) is the probability that the feature point of the transition source appears in the latent space 152, and p(z′) is the probability that the feature point of the transition destination appears in the latent space 152. The local transition algorithm may be implemented so as to satisfy the detailed balance condition instead of the balance condition.

$$\int p ( z ) {z}_{} ( {z}^{′} \vert z ) dz = p ( {z}^{′} ) \qquad ( 6 )$$

In the latent space 152, the information processor 100 may make an independent proposal that selects the feature point 155 without depending on the feature point 154, instead of a local transition that selects the feature point 155 depending on the feature point 154. However, the local selection is more likely to propose the sample 156 with a higher adoption probability than the independent proposal, which therefore improves sampling efficiency.

Next, the effectiveness of the local proposal distribution of the second embodiment is described in more detail. In the Metropolis method, the ratio of transition probabilities used in the calculation of the adoption probability is important. According to the transition probability defined in Equation (5), the ratio of the transition probability of transitioning from state x to state x′ to the transition probability of transitioning from state x′ to state x is calculated as defined in Equation (7).

$$\frac{{q}_{θ , ϕ} ( {x}^{′} \vert x )}{{q}_{θ , ϕ} ( x \vert {x}^{′} )} = \frac{{q}_{ϕ} ( z \vert x ) {z}_{} ( {z}^{′} \vert z ) {p}_{θ} ( {x}^{′} \vert {z}^{′} )}{{q}_{ϕ} ( {z}^{′} \vert {x}^{′} ) {z}_{} ( z \vert {z}^{′} ) {p}_{θ} ( x \vert z )} \qquad ( 7 )$$

Because a loss function used to train a variational autoencoder takes a minimum value when p_{θ}(z|x)=q_{φ}(z|x), the ratio defined in Equation (7) is approximated as in Equation (8) in a highly accurate variational autoencoder. Furthermore, using a formula for conditional probability, Equation (8) is transformed into Equation (9). Therefore, if the variational autoencoder is able to learn the true probability distribution p(x) with high accuracy, the adoption probability A(x′|x) defined in Equation (3) is close to 1, thus improving sampling efficiency.

$$\frac{{q}_{θ , ϕ} ( {x}^{′} \vert x )}{{q}_{θ , ϕ} ( x \vert {x}^{′} )} \approx \frac{{p}_{θ} ( z \vert x ) {z}_{} ( {z}^{′} \vert z ) {p}_{θ} ( {x}^{′} \vert {z}^{′} )}{{p}_{θ} ( {z}^{′} \vert {x}^{′} ) {z}_{} ( z \vert {z}^{′} ) {p}_{θ} ( x \vert z )} \qquad ( 8 )$$

$$\frac{{q}_{θ , ϕ} ( {x}^{′} \vert x )}{{q}_{θ , ϕ} ( x \vert {x}^{′} )} \approx \frac{{p}_{θ} ( x , z ) {p}_{θ} ( {x}^{′} , {z}^{′} )}{{p}_{θ} ( x ) {p}_{θ} ( {z}^{′} )} \frac{{p}_{θ} ( {x}^{′} ) {p}_{θ} ( z )}{{p}_{θ} ( {x}^{′} , {z}^{′} ) {p}_{θ} ( x , z )} \frac{{p}_{θ} ( {z}^{′} )}{{p}_{θ} ( z )} = \frac{{p}_{θ} ( {x}^{′} )}{{p}_{θ} ( x )} \qquad ( 9 )$$

Next described is an example of sampling using the self-learning Monte Carlo method with a variational autoencoder. Two task examples are given here: a continuous task and a discrete task. The continuous task extracts samples from a continuous probability distribution. Specifically, the continuous task extracts samples from a 200-dimensional and two-cluster Gaussian mixture distribution. The discrete task extracts samples from a discrete probability distribution. Specifically, the discrete task extracts samples from an Ising model defined in Equation (10). Here, N=400 and β=0.447 are used. A random variable x is a 400-dimensional vector with each dimensional component being −1 or 1.

$$p ( x ) = \frac{{e}^{β {\sum }_{( i , j )} {x}_{i} {x}_{j}}}{{{\sum }_{x}}_{} {e}^{β ( {\sum }_{( i , j )} {x}_{i} {x}_{j} + h {\sum }_{i} {x}_{i} )}} , {x}_{i} ∈ \{ - 1 , 1 \} , i = 1 , … , N \qquad ( 10 )$$

For each of the above continuous and discrete tasks, the information processor 100 extracts samples by the self-learning Monte Carlo method using a variational autoencoder. For comparison, the information processor 100 carries out a method using an independent proposal, in addition to a method using a local transition, to select the next feature point in the latent space. In the method using an independent proposal, the information processor 100 selects the next feature point according to a multivariate standard normal distribution. In this case, the proposal probability of a proposed sample is calculated as defined in Equation (11).

$$q ( {x}^{′} ) = ( {z}^{′} ; {0}_{M} , {I}_{M} ) {p}_{θ} ( {x}^{′} \vert {z}^{′} ) \qquad ( 11 )$$

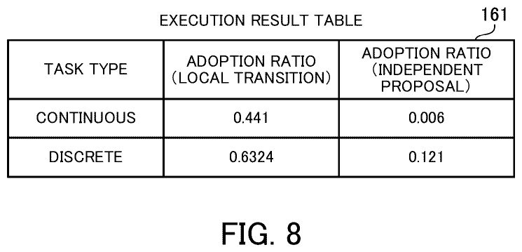

FIG. 8 illustrates an example of an execution result table. An execution result table 161 represents the rate of samples that are adopted among multiple samples proposed by the variational autoencoder. The execution result table 161 indicates the adoption rate of the case where the above continuous task is executed by local transitions in the latent space, and the adoption rate of the case where the above discrete task is executed by local transitions in the latent space. Furthermore, the execution result table 161 indicates the adoption rate of the case where the continuous task is executed by independent proposals in the latent space, and the adoption rate of the case where the discrete task is executed by independent proposals in the latent space.

As represented in the execution result table 161, for both the continuous and discrete tasks, using local transitions in the latent space has a higher adoption rate than using independent proposals, thus leading to efficient extraction of valid samples.

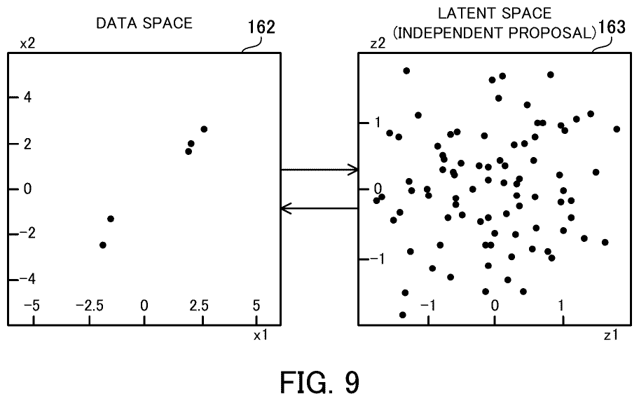

FIG. 9 illustrates an example of sampling results obtained by independent proposals. FIG. 9 depicts the selection tendency when the above continuous task is executed by the method using independent proposals. In the independent proposals, feature points are randomly selected from an entire latent space 163. However, in a data space 162, many of the proposed samples are rejected, and only a few samples remain.

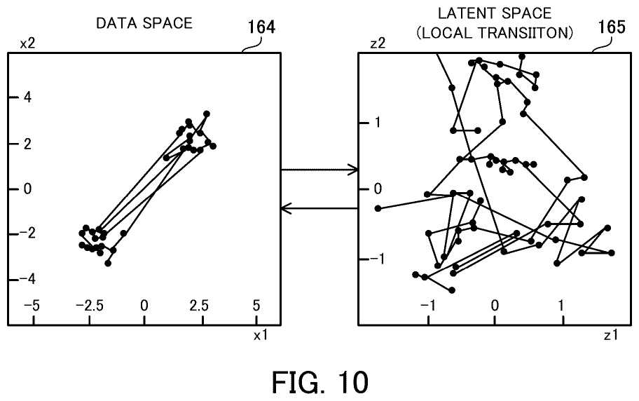

FIG. 10 illustrates an example of sampling results obtained by local transitions. FIG. 10 depicts the selection tendency when the above continuous task is executed by the method using local transitions. In a latent space 165, because the probability distribution is a smooth unimodal distribution, the transition destinations are selected mainly from the vicinity of the peak but yet from a fairly wide range.

In a data space 164, the local transitions in the latent space 165 have been converted into transitions between samples belonging to different peaks, and the sample sequence approximates a multimodal distribution. In addition, the rate of adopted samples among the proposed samples is large, and thus many samples remain. In this way, the local transitions in the latent space indicated by the variational autoencoder reflect the multimodal distribution in the sample sequence, and efficiently extract effective samples. Next described are the functions and processing procedures of the information processor 100.

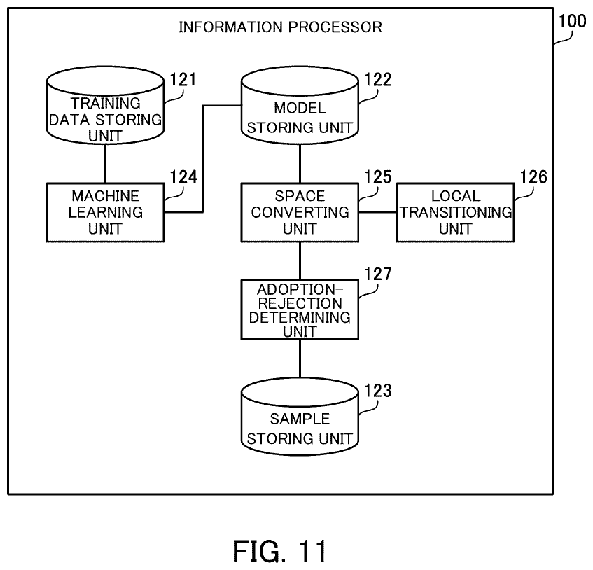

FIG. 11 is a block diagram illustrating an example of functions of an information processor. The information processor 100 has a training data storing unit 121, a model storing unit 122, a sample storing unit 123, a machine learning unit 124, a space converting unit 125, a local transitioning unit 126, and an adoption-rejection determining unit 127. The training data storing unit 121, the model storing unit 122, and the sample storing unit 123 are implemented using, for example, the RAM 102 or the HDD 103. The machine learning unit 124, the space converting unit 125, the local transitioning unit 126, and the adoption-rejection determining unit 127 are implemented using, for example, the CPU 101, the GPU 104, and a program.

The training data storing unit 121 stores training data for training the variational autoencoder. The training data may be input by a user. Alternatively, the training data may be generated through sampling from a probability distribution according to an equation of the probability distribution specified by the user. The model storing unit 122 stores the trained variational autoencoder. The sample storing unit 123 stores multiple extracted samples. The samples stored in the sample storing unit 123 may be used for physical simulations or statistical processing.

The machine learning unit 124 trains the variational autoencoder by machine learning using the training data stored in the training data storing unit 121. This optimizes the encoder parameters φ and the decoder parameters θ included in the variational autoencoder. The machine learning unit 124 may generate the training data. The machine learning unit 124 stores the trained variational autoencoder in the model storing unit 122.

The space converting unit 125 converts a sample in the data space and a feature point in the latent space using the variational autoencoder stored in the model storing unit 122. The space converting unit 125 converts a sample into a feature point using the encoder, and converts a feature point into a sample using the decoder. The local transitioning unit 126 identifies a current feature point in the latent space indicated by the variational autoencoder, and selects the next feature point by a local transition.

The adoption-rejection determining unit 127 calculates the adoption probability for the sample candidate selected through the space converting unit 125 and the local transitioning unit 126. The adoption probability is calculated depending on the trained variational autoencoder and the algorithm used for the local transition. The adoption-rejection determining unit 127 determines whether to adopt the sample based on the calculated adoption probability and a random number. The adoption-rejection determining unit 127 stores the adopted sample in the sample storing unit 123.

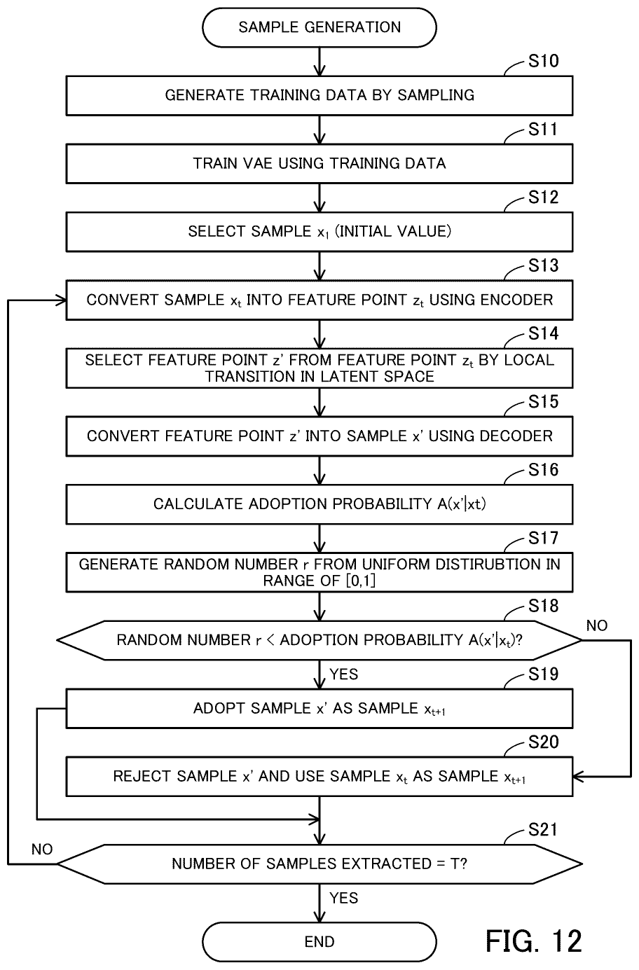

FIG. 12 is a flowchart illustrating an example of sample generating procedures. In step S10, the machine learning unit 124 generates training data including multiple samples by extracting samples from a specified probability distribution using a certain sampling method. In step S11, the machine learning unit 124 initializes parameters included in the variational autoencoder. The machine learning unit 124 trains the variational autoencoder by error backpropagation using the training data generated in step S10.

In step S12, the space converting unit 125 selects a sample x₁, which is an initial value, from the data space. The initial value may be selected randomly or may be selected with reference to the true probability distribution of the data space. In step S13, the space converting unit 125 converts a sample xₜ into a feature point zₜ in the latent space using an encoder included in the trained variational autoencoder. The sample xₜ is the t-th sample included in the sample sequence, and the feature point zₜ is the t-th feature point selected in the latent space. Through the loop of steps S13 to S21, t increases by 1 from 1 to T.

In step S14, the local transitioning unit 126 selects a feature point z′ from the feature point zₜ identified in step S13 by a local transition in the latent space. In step S15, the space converting unit 125 converts the feature point z′ selected in step S14 into a sample x′ in the data space using a decoder included in the trained variational autoencoder.

In step S16, the adoption-rejection determining unit 127 calculates the adoption probability A(x′|xₜ) that the sample x′ is adopted after the sample xₜ, using the trained variational autoencoder and the local transition algorithm. In step S17, the adoption-rejection determining unit 127 draws the random number r from a uniform distribution in the range of 0 to 1, inclusive. In step S18, the adoption-rejection determining unit 127 determines whether the random number r generated in step S17 is smaller than the adoption probability A(x′|xₜ) calculated in step S16. If the random number is smaller than the adoption probability, the process proceeds to step S19, and if the random number is equal to or greater than the adoption probability, the process proceeds to step S20.

In step S19, the adoption-rejection determining unit 127 adopts the sample x′ as a sample xₜ₊₁. The sample xₜ₊₁ is the t+1-th sample included in the sample sequence, and is the sample following the sample xₜ. Then, the process proceeds to step S21. In step S20, the adoption-rejection determining unit 127 rejects the sample x′ and copies the sample xₜ to use it as the sample xₜ₊₁. This means that the state in the data space remains as the current state.

In step S21, the adoption-rejection determining unit 127 determines whether T samples have been extracted. A threshold T is specified by the user, for example. When t+1=T, T samples have already been extracted. If T samples have been extracted, the sample generation ends, and if T samples have not been extracted, the process returns to step S13.

Note that the information processor 100 may retrain the variational autoencoder while generating samples. For example, the information processor 100 sets ΔT which is smaller than T. Each time ΔT samples are extracted, the information processor 100 adds the extracted samples to the training data and retrains the variational autoencoder using the extended training data.

In addition, when the previously proposed sample x′ is rejected, the information processor 100 may use a feature point zₜ₋₁ as the feature point zₜ, thereby omitting step S13. Furthermore, when the previously proposed sample x′ is adopted, the information processor 100 may use the previously selected feature point z′ as the feature point zₜ, thereby omitting step S13.

As has been described above, the information processor 100 of the second embodiment extracts samples from a data space by the Markov chain Monte Carlo method. Herewith, even if the data space is high-dimensional, the information processor 100 extracts samples so as to conform to the probability distribution. In addition, the information processor 100 implements a proposal distribution that approximates an original probability distribution as a machine learning model by the self-learning Monte Carlo method. As a result, the adoption probabilities of proposed samples tend to be high, which makes sampling more efficient.

Furthermore, the information processor 100 selects a feature point in a latent space and converts the feature point into a sample using a variational autoencoder to propose a candidate for the next sample. A well-trained variational autoencoder maps small changes in feature points in the latent space to large changes in samples in the data space. This allows the information processor 100 to reduce the risk that the sampling range is closed to a partial region even if the original probability distribution is a multimodal distribution, and to extract a high-quality sample sequence that reflects the multimodal distribution.

In addition, the information processor 100 performs a local transition in the latent space to select the next feature point based on the feature point corresponding to the previous sample. This tends to increase the adoption probability of a sample proposed by the variational autoencoder compared to the case where a feature point is selected regardless of the previous sample, which makes sampling more efficient.

According to one aspect, it is possible to efficiently extract sample data pieces that conform to a particular probability distribution.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring first sample data included in a data space which conforms to a first probability distribution;
selecting, by use of a machine learning model that maps the data space and a latent space which conforms to a second probability distribution to each other, a second latent representation in the latent space based on a first latent representation in the latent space, the first latent representation corresponding to the first sample data; and
outputting, by use of the machine learning model, second sample data corresponding to the second latent representation from among sample data included in the data space.

2. The non-transitory computer-readable recording medium according to claim 1, wherein:
the machine learning model is a variational autoencoder,
the selecting includes converting, by use of an encoder included in the variational autoencoder, the first sample data into the first latent representation, and
the outputting includes converting, by use of a decoder included in the variational autoencoder, the second latent representation into the second sample data.

3. The non-transitory computer-readable recording medium according to claim 1, wherein:
the selecting includes selecting the second latent representation by stochastically transitioning the first latent representation by use of a gradient of the second probability distribution at the first latent representation.

4. The non-transitory computer-readable recording medium according to claim 1, wherein:
the outputting includes calculating an adoption probability indicating whether to adopt the second sample data based on a transition probability of transitioning from the first latent representation to the second latent representation, an extraction probability of extracting the first sample data indicated by the first probability distribution, and an extraction probability of extracting the second sample data indicated by the first probability distribution.

5. An information processing method comprising:
acquiring, by a processor, first sample data included in a data space which conforms to a first probability distribution;
selecting, by the processor, by use of a machine learning model that maps the data space and a latent space which conforms to a second probability distribution to each other, a second latent representation in the latent space based on a first latent representation in the latent space, the first latent representation corresponding to the first sample data; and
outputting, by the processor, by use of the machine learning model, second sample data corresponding to the second latent representation from among sample data included in the data space.

6. An information processing apparatus comprising:
a memory configured to store a machine learning model that maps a data space which conforms to a first probability distribution and a latent space which conforms to a second probability distribution to each other; and
a processor coupled to the memory and the processor configured to:
acquire first sample data included in the data space,
select, by use of the machine learning model, a second latent representation in the latent space based on a first latent representation in the latent space, the first latent representation corresponding to the first sample data, and
output, by use of the machine learning model, second sample data corresponding to the second latent representation from among sample data included in the data space.
